(19) United States
(12) Patent Application Publication
(10) Pub. No.: US 2023/0323059 A1
(43) Pub. Date: Oct. 12, 2023

(54) HEAT STABLE MULTILAYER BARRIER FILM STRUCTURE

(71) Applicant: AMCOR FLEXIBLES NORTH AMERICA, INC., NEENAH, WI (US)

(72) Inventors: Philipp OKLE, Konstanz (DE); Wolfgang Lohwasser, Gailingen (DE); Peter Ettridge, Worcester (GB); Roy Christopherson, Shrivenham (GB)

(21) Appl. No.: 18/022,308

(22) PCT Filed: Sep. 9, 2021
(86) PCT No.: PCT/US2021/049614

§ 371 Date: Feb. 21, 2023

Related U.S. Application Data
(60) Provisional application No. 63/077,240, filed on Sep. 11, 2020.

(51) Int. Cl. C08J 7/048; C08J 5/18

(52) U.S. Cl. CPC C08J 7/048; C08J 5/18; C08J 2375/04; C08J 2323/12

(57) ABSTRACT

A durable barrier film including a polymeric substrate layer having a thickness between (10) and (100) pm, an inorganic coating layer, and a polymeric buffer layer positioned between the polymeric substrate layer and the inorganic coating layer, the polymeric buffer layer in direct contact with the inorganic coating layer, wherein the inorganic coating layer comprises a wave structure characterized by an average amplitude between (0.25) and (1.0) pm and a wavelength between (2) and (5) pm.

### TECHNICAL FIELD

The present invention is related to heat stable multilayer barrier film structures, in particular flexible multilayer films for packaging applications. The barrier structures contain one or more inorganic coating layers in contact with at least one buffer layer in a multilayer laminate. The presence of the buffer layer allows the formation of waves in the inorganic coating layer and thereby avoiding the formation of cracks when a substrate layer shrinks under thermal stress. The usual loss of oxygen and water vapor transmission rate is thereby reduced, and the transmission rates of the film remain acceptable even after heat treatment.

### BACKGROUND

A typical packaging application involving the exposure of a multilayer barrier structure to thermal stress is retort packaging. In retort packaging, the packaged product undergoes an extended heat and pressure treatment process. Similarly, packaging or packaged product may undergo a pasteurization process at about 80° C. In still another application multilayer barrier structures may be used as a thermal shrink wrap foil at temperatures of 80° C. or lower.

Multilayer heat shrinkable films for use as wrapping foils are for example disclosed in US patent documents US2006222793 and U.S. Pat. No. 6,627,274.

Food products are increasingly being packaged in flexible retort packages as an alternative to metal cans and glass jars. The packaging material for flexible retort packages typically includes an embedded barrier layer, an outer polymer layer adhered to one side of the barrier layer and forming the exterior surface of the package, and a heat-sealable inner polymer film layer adhered to the other side of the gas barrier layer and forming the interior surface of the package. This combination of layers can withstand a retort process without melting or substantially degrading (i.e. leaking, delaminating). In general, retorting consists in heating the packaging container to a temperature between 100 and 135° C., at an overpressure between 0.5 and 1.1 bar, for a time period between 20 and 100 minutes.

Laminates for retort packaging are disclosed for example in U.S. Pat. Nos. 4,310,578 A; 4,311,742 A; 4,308,084 A; 4,309,466 A; 4,402,172 A; 4,903,841 A; 5,273,797 A; 5,731,090 A; EP 1 466 725 A1; JPH 09 267 868 A; JP 2002 096 864 A; JP 2015 066 721 A; JP 2018 053 180 A; JP 2017 144 648 A; JPS 62 279 944 A; JPS 6 328 642 and JPH 10 244 641 A.

Conventional flexible retort pouches are manufactured with layers of different materials to achieve oxygen, water, bacteria and flavor barrier properties. One typical option for designing resilient retort packaging multilayer barrier films is the use of an aluminum barrier layer of at least 5 μm, preferably more than 12 μm thickness. Nevertheless, aluminum is expensive, of high density, subject to pinholes at lower thicknesses after flexing and has the drawback of opacity. Aluminum is also known to cause problems for reheating a packaged food product in a microwave oven. Moreover, the presence of a metal layer is in general undesirable in terms of recycling possibilities and metal detection within the packaging process.

A typical example of a multilayer barrier film structure for standard retort pouches comprises a polyethylene terephthalate outer layer, a barrier layer, and an inner sealing layer, wherein the outer layer in general comprises a printing layer, the barrier layer is a metal foil, a metallized film, or a transparent barrier polymer film and the inner layer is a heat sealable polyolefin layer. The packaging material may also contain an additional polymer film layer such as a polyamide layer or the like.

Besides the recycling issue, due to the presence of the integrated aluminum foil, the diversity of the polymer layers composing the multilayer barrier film structure results in an additional problem for rendering this film structures recyclable.

Without contesting the associated advantages of the state-of-the-art systems, it is nevertheless obvious that there is still a need for a recyclable heat stable multilayer barrier film structure for packaging, wherein the barrier layer remains substantially crack-free during heat treatment, thereby limiting the loss of oxygen and water vapor barrier properties of the film.

### SUMMARY

The present invention aims to provide a durable (i.e. heat resilient) multilayer barrier film structure for packaging to be heat treated, for example during a pasteurization or a retort treatment, said film structure comprising an inorganic barrier layer remaining substantially crack-free during and after the heat treatment, thereby limiting the increase of oxygen and water vapor transmission rate of the film.

It is a further aim of the present invention to provide a more sustainable transparent multilayer barrier film showing outstanding oxygen transmission rate (low transmission, high barrier), said oxygen transmission rate remaining substantially unchanged after heat treatment, the structure being relatively easier to recycling than current durable high barrier structures.

Disclosed herein are durable barrier films which have a polymeric substrate layer, an inorganic coating layer, and a polymeric buffer layer positioned between the polymeric substrate layer and the inorganic coating layer. The polymeric buffer layer is in direct contact with the inorganic coating layer. The polymeric substrate layer has a free shrink between 0.5% and 50% in at least one of the machine direction or the transverse direction at the shrink onset temperature of the durable barrier film according to ASTM D2732. The inorganic coating layer has a thickness between 0.005 μm and 0.1 μm. The polymeric buffer layer comprises a thickness between 0.5 μm and 12 μm. A ratio of the thickness of the polymeric buffer layer to the thickness of the inorganic coating layer is between 20 and 500. The polymeric buffer layer comprises a Youngs modulus (i.e. elastic modulus) at the shrink onset temperature between 0.1 and 100 MPa, as calculated from measurements collected according to ASTM E2546-15 with Annex X.4.

Embodiments of the durable barrier film may have one or more of the following features:

the polymeric buffer layer has a thickness between 1 and 5 μm;

the inorganic coating layer is a metal layer or an oxide coating layer and the thickness of the inorganic coating layer is between 0.005 μm and 0.06 μm;

the ratio of the thickness of the polymeric buffer layer to the thickness of the inorganic coating layer is between 30 and 120;

the polymeric substrate layer includes a monoaxially oriented polypropylene film, a biaxially oriented polypropylene film, a monoaxially oriented polyethylene film, a biaxially oriented polyethylene film, a monoaxially oriented polyester films or a biaxially oriented polyester film, and the polymeric substrate layer has a thickness between 6 μm and 100 μm;

the polymeric substrate layer includes an oriented polyolefin film; the polymeric substrate layer has a free shrink of between 1% and 6% at the shrink onset temperature according to ASTM D2732;

the polymeric buffer layer includes vinyl alcohol copolymer, polypropylene-based polymer, polyurethane-based polymer or polylactic acid; and

further having a second polymeric buffer layer in direct contact with the inorganic coating layer.

In some embodiments of the durable barrier film the polymeric substrate layer includes biaxially oriented polypropylene having a thickness between 10 and 50 μm, the inorganic coating layer is vacuum deposited aluminium, AlOx or SiOx, the thickness of the inorganic coating layer is between 0.01 and 0.1 μm, the polymeric buffer layer is polyurethane and the thickness of the polymeric buffer layer is between 1 and 2.5 μm.

Some embodiments of the durable barrier film include a polymeric substrate layer of monoaxially oriented polyethylene film, a polymeric buffer layer of vinyl alcohol copolymer (i.e. EVOH), and an inorganic coating layer of vacuum deposited metal, e.g. aluminum, AlOx or SiOx.

Another embodiment of the durable barrier film includes a polymeric substrate layer, an inorganic coating layer, and a polymeric buffer layer positioned between the polymeric substrate layer and the inorganic coating layer, as previously described. Again, the polymeric buffer layer is in direct contact with the inorganic coating layer. These versions include a polymeric substrate layer having a free shrink between 0.5% and 50% at 60° C. according to ASTM D2732. The inorganic coating layer has a thickness between 0.005 μm and 0.1 μm, the polymeric buffer layer has a thickness between 0.5 and 12 μm, a ratio of the thickness of the polymeric buffer layer to the thickness of the inorganic coating is between 20 and 500, and the polymeric buffer layer having a Youngs modulus at temperature of 60° C., between 0.1 and 100 MPa, as calculated from measurements collected according to ASTM E2546-15 with Annex X.4. Other embodiments of the durable barrier film could have a polymeric substrate layer having a free shrink between 0.5% and 50% and a polymeric buffer layer having a Youngs modulus between 0.1 and 100 MPa, at a temperature of 40° C., 50° C., 70° C., 75° C., 80° C., 85° C., 90° C., 95° C., 100° C. or 110° C.

The durable barrier film may also include a wave structure. In these embodiments the film includes a polymeric substrate layer, an inorganic coating layer, and a polymeric buffer layer positioned between the polymeric substrate layer and the inorganic coating layer. The polymeric buffer layer is in direct contact with the inorganic coating layer. The polymeric substrate layer has a thickness between 10 μm and 100 μm. The inorganic coating layer includes a wave structure characterized by an average amplitude between 0.25 μm and 1.0 μm and a wavelength between 2 μm and 5 μm. The polymeric buffer layer has a thickness between 1.1 and 20 times the average amplitude of the wave structure.

In some embodiments of the durable barrier film, the inorganic coating has a wave structure characterized by a ratio of the wavelength to the average amplitude between 2 and 20. The durable barrier film with an inorganic layer having a wave structure may include an inorganic layer of a metal layer or oxide coating and the thickness of the inorganic coating layer may be between 0.005 μm and 0.1 μm.

In some embodiments of the durable barrier film, the polymeric substrate layer is a monoaxially oriented polypropylene film, a biaxially oriented polypropylene film, a monoaxially oriented polyethylene film, a biaxially oriented polyethylene film, a monoaxially oriented polyester films or a biaxially oriented polyester film. The polymeric substrate layer may be an oriented polyolefin film. The polymeric buffer layer may include polypropylene, polyurethane or polylactic acid.

Some embodiments of the durable barrier film may include a second polymeric buffer layer in direct contact with the inorganic coating layer. The durable barrier film may further include one or more additional polyolefin layers.

Some embodiments of the durable barrier film have a polymeric substrate layer of a biaxially oriented polypropylene film with a thickness between 10 and 50 μm and an inorganic coating layer of a vacuum deposited aluminium, AlOx or SiOx. The thickness of the inorganic coating layer may be between 0.01 and 0.1 μm. The average amplitude of the wave structure may be comprised between 0.4 μm and 1.0 μm.

Some embodiments of the durable barrier film include a polymeric substrate layer of a monoaxially oriented polyethylene film, a polymeric buffer layer of EVOH copolymer, and an inorganic coating layer of vacuum deposited aluminium, AlOx or SiOx. The average amplitude of the wave structure within the inorganic coating layer is between 0.15 μm and 1.0 μm, and the wavelength of the wave structure is between 1 μm and 4 μm. The polymeric buffer layer may include polyurethane.

Also disclosed herein are methods for the production of the durable barrier films. The method includes steps of:
providing a polymeric substrate layer,
applying a polymeric buffer layer to a surface of the polymeric substrate layer by techniques including extrusion, lacquering, spray coating, or solvent evaporation, and
applying an inorganic coating layer to a surface of the polymeric buffer layer by vacuum deposition.

The method may also include:
applying a second polymeric buffer layer to a surface of the polymeric substrate layer by techniques comprising extrusion, lacquering, spray coating, solvent evaporation, and
adhering one or more additional polyolefin layers to a surface of one or more of the polymeric substrate layer, the inorganic coating layer, the second polymeric buffer layer or another additional polyolefin layer.

Also disclosed herein are hermetically sealed packages or retort stable packages which include the durable barrier film. In some retort stable packages the ratio of the oxygen transmission rate, according to ASTM 3985-2005, at 25° C. and 50% relative humidity, after retort treatment, to the oxygen transmission, rate before retort treatment, of said multilayer barrier film is equal to or less than 5, and the oxygen transmission rate, according to ASTM 3985-2005, at 25° C. and 50% relative humidity is less than 0.5 cm³/(m² 24 h bar) before retort treatment and is less than 1 cm³/(m² 24 h bar) after retort treatment at 127° C. during 50 minutes.

Methods of producing a shelf-stable packaged product are also disclosed herein. An embodiment of the process includes 1) providing the durable barrier film and forming the film into a package, 2) filling the package with a product, 3) hermetically sealing the product inside the package to form a packaged product, and 4) exposing the packaged product to sterilization conditions wherein the sterilization conditions include an elevated temperature that is greater than the shrink onset temperature of the durable barrier film. Another embodiment of the process includes 1) providing the durable barrier film and exposing the film to a heat treatment including a temperature that is greater than the shrink onset temperature of the durable barrier film, resulting in a durable barrier film including a wave structure, 2) forming the film into a package, 3) filling the package with a product, 4) hermetically sealing the product inside the package to form a packaged product, and 5) exposing the packaged product to sterilization conditions.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an embodiment of a durable barrier film prior to heat treatment and wave structure formation;

FIG. 2 is a cross-sectional view of an embodiment of a durable barrier film after heat treatment and wave structure formation;

FIG. 3 is a cross-sectional view of an embodiment of a durable barrier film prior to heat treatment and wave structure formation;

FIG. 4 is a cross-sectional view of an embodiment of a durable barrier film after heat treatment and wave structure formation;

FIG. 5 is a top-view of a magnification of a wave structure formed in an embodiment of a durable barrier film;

FIG. 6 is a perspective view of an embodiment of a hermetically sealed package formed using a durable barrier film;

FIG. 7 is a perspective view of an embodiment of a retort stable package formed using a durable barrier film; and

FIGS. 8A-8C are enlarged micrographs of the top view of films which formed waves (8A and 8C) and a comparative film that does not form waves (8B) (note that these photos are not at the same magnification).

The drawings show some but not all embodiments. The elements depicted in the drawings are illustrative and not necessarily to scale, and the same (or similar) reference numbers denote the same (or similar) features throughout the drawings.

### DETAILED DESCRIPTION

The durable barrier film structure according to the present invention includes at least one heat-shrinkable polymeric substrate layer, at least one inorganic coating layer and at least one polymeric buffer layer, the polymeric buffer layer in direct contact with the inorganic coating layer and positioned between the polymeric substrate layer and the inorganic coating layer. During exposure to temperatures high enough to cause the barrier film to shrink, the role of the buffer layer is to be a malleable interface between the shrinking substrate layer and the stiff and non-shrinking inorganic coating layer, allowing a continuous wave structure to form within the inorganic layer at the surface of the buffer layer. By formation of this wave structure, cracks within the inorganic coating layer can be substantially reduced and the loss of oxygen and water vapor barrier due to the shrinking substrate layer can be mitigated.

The wave structure formation effect of the inorganic layer on the buffer layer is obtained by a subtle equilibrium between 1) polymeric buffer layer thickness, 2) elastic modulus of the polymeric buffer material at the heat treatment temperature and 3) the thickness of the inorganic layer. At and above the temperature at which the substrate layer begins to shrink (i.e. shrink onset temperature), the buffer layer must have a modulus such that it can change shape. The shape change is a result of a shrinking surface area on the side of the buffer layer nearest the shrinking substrate layer and the non-shrinking surface area on the side of the buffer layer adjacent the inorganic coating layer. Due to its low modulus, the surface of the buffer layer adjacent to the substrate layer can move and adjust to the shrinking force. The buffer layer adjacent to the inorganic layer conforms to a wave structure to accommodate for the unchanging surface area of the inorganic coating layer. The wave structure of the inorganic coating may form in one or more patterns including but not limited to regular (i.e. stripes), herringbone and random (i.e. labyrinths). The formation of the waves allows the inorganic coating layer to flex, retaining its original area and remain intact, without cracks (or without as many cracks), reducing or eliminating the degradation of the barrier of this layer that can occur due to shrinking of the substrate layer.

Without limiting the current invention, a model used to describe the theoretical formation of waves in various systems can be found in Huang, Z Y, Hong, W, Suo Z 2005, ‘Nonlinear Analysis of Wrinkles in a Film Bonded to a Compliant Substrate’, Journal of the Mechanics and Physics of Solids, 53, 2101-2118.

“Shrink Onset Temperature” as used herein is the temperature at which the durable barrier film demonstrates a free shrink of at least 1% in at least one of the MD or the TD. “Free Shrink” as used herein is an unrestrained linear shrinkage that a film or layer undergoes due to exposure to elevated temperature. The shrink is irreversible and relatively rapid (i.e. evident within seconds or minutes). Free shrink is expressed as a percentage of the original dimension, (i.e. 100×(pre-shrink dimension−post-shrink dimension)/(pre-shrink dimension)). Free shrink can be measured using ASTM D2732. Alternatively, free shrink can be measured by using the test method described in ASTM D2732 with a modification of using hot air as the heating source instead of a hot fluid bath. If using the hot air method, place the unrestrained sample in the oven set at the specified temperature for a time span of at least 1 minute, giving the oven interior and sample ample time to come to thermal equilibrium. To determine the shrink onset temperature, perform the free shrink test at 10° C. increasing increments until the material shrinks at least 1% in one or both of the machine direction and the transverse direction. The temperature at which the free shrink is at least 1% in at least one direction (MD or TD) is the shrink onset temperature. Practical shrink onset temperatures for the durable barrier films described herein may be between 50° C. and 200° C.

“Polymeric Buffer Layer” as used herein is a layer within the durable barrier film, directly adjacent to and in contact with the inorganic coating layer, having the function of allowing the inorganic coating layer to flex from a relatively flat cross-sectional geometry into a wave structure. The polymeric buffer layer is formulated such that the material or blend of materials becomes malleable in the temperature range at which the durable barrier film experiences slight shrinking due to thermal exposure (i.e. at the shrink onset temperature of the durable barrier film), as is further described herein. The formula of the polymeric buffer layer can be directed toward achieving an elastic modulus in the appropriate temperature range that allows the material to be pliable.

As used herein, layers or films that are “in direct contact with” or “are directly adjacent to” each other have no intervening material between them.

“Inorganic Coating Layer” as used herein refers to a layer that comprises a metal layer or an oxide coating layer. These layers function for barrier purposes. The inorganic coating layer may be vacuum deposited (i.e. vacuum coated, vapor coated, vacuum metalized) directly on the surface of the buffer layer. Alternatively, the inorganic coating layer may be deposited by wet chemistry methods, such as solution coating.

As described herein, the polymeric substrate layer may be oriented. Orientation may be the result of monoaxially oriented (machine direction or transverse direction), or biaxially oriented (machine direction and transverse direction) stretching of the film, increasing the machine direction and/or transverse direction dimension and subsequently decreasing the thickness of the material. Biaxial orientation may be imparted to the film simultaneously or successively. Stretching in either or both directions is subjected to the film in the at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by a double- or triple-bubble process, by a tenter-frame process or an MDO process using heated rolls. A typical blown film process does impart some stretching of the film, but not enough to be considered oriented as described herein. An oriented film may be heat set (i.e. annealed) after orientation, such that it is relatively dimensionally stable under elevated temperature conditions that might be experienced during conversion of the retort film laminate (i.e. printing or laminating) or during the use of the laminate (i.e. heat sealing or retort sterilization).

As used herein, the term “polyolefin” generally includes polypropylene and polyethylene polymers.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to terpolymers, quaterpolymers, etc.

As used throughout this application, the term “polypropylene” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, for example, homopolymer polypropylene, polypropylene impact copolymer, polypropylene random copolymer, etc. Various polypropylene polymers may be recycled as reclaimed polypropylene or reclaimed polyolefin.

As used throughout this application, the term “polyethylene” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, or blends of such. Various polyethylene polymers may be recycled as reclaimed polyethylene or reclaimed polyolefin.

As used throughout this application, the term “polyester” or “PET” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers.

As used herein, the term “polyamide” refers to a high molecular weight polymer having amide linkages (—CONH—)n which occur along the molecular chain, and includes “nylon” resins which are well known polymers having a multitude of uses including utility as packaging films. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 61/6T. Examples of polyam ides include nylon homopolymers and copolymers such as nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof. Polyamide is used in films for food packaging and other applications because of its unique physical and chemical properties. Polyamide is selected as a material to improve temperature resistance, abrasion resistance, puncture strength and/or barrier of films. Properties of polyamide-containing films can be modified by selection of a wide variety of variables including copolymer selection, and converting methods (e.g. coextrusion, orientation, lamination, and coating).

As used herein, “polyurethane” is generally referencing polymers having organic units joined by urethane links (—NH—(C═O)—O—).

As used herein, “polylactic acid” is a polymer made from lactic acid and having a backbone of [—C(CH₃)HC(═O)O—]ₙ.

As used throughout this application, the term “vinyl alcohol copolymer” refers to film forming copolymers of vinyl alcohol (CH₂CHOH). Examples include, but are not limited to, ethylene vinyl alcohol copolymer (EVOH), butenediol vinyl alcohol copolymer (BVOH), and polyvinyl alcohol (PVOH).

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂ —CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

The term “layer”, as used herein, refers to a building block of a film that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. A film has two major surfaces, the area of which are defined by the length and width of the film.

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

“Wave structure” as used herein refers to a cross-sectional geometry of the inorganic coating layer and the surface of the adjacent polymeric buffer layer(s). As with any wave, the wave structure has a wavelength, measurable in the x-y direction, and an amplitude, measurable in the z-direction.

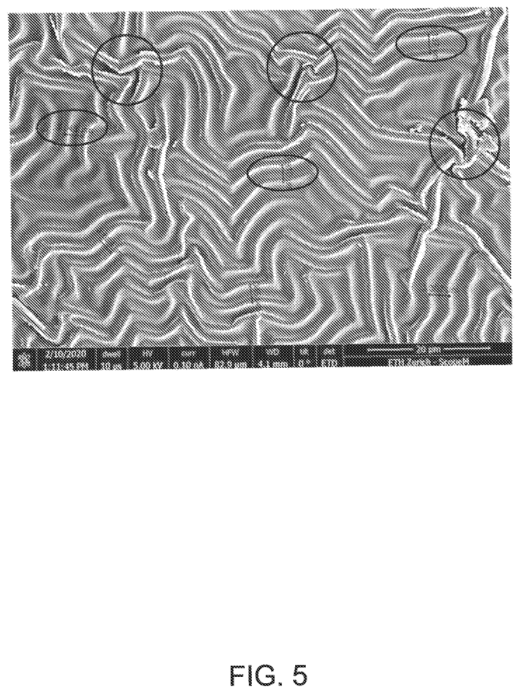

The wavelength of the wave structure can be determined using top view microscopy techniques including, but not limited to, optical microscopy, laser scanning microscopy, electron microscopy, atomic force microscopy. The resolution of the microscope needs to be sufficient to identify features on the waves, as i.e. wave peaks and wave valleys. An example of a representative top view microscopy is shown in FIG. 5. As shown in this view, the waves take various patterns and are organized into wave domains, or sections where the waves are regular and ordered. The wave domains meet at corners or edges and form irregular folds or intersections. Measurements of the waves can be executed in the wave domains, examples of which are indicated by superimposed ovals. Variations in wave measurements can occur at the intersections, examples of which are indicated by superimposed circles, as the colliding waves interfere with the regular pattern. The intersections of waves are not used for wave measurements.

The wavelength is the distance between either peak to peak or valley to valley in an undistorted area of waves (i.e. wave domain). An average wavelength is calculated by taking the average of at least 5 individual wavelength measurements.

Other techniques to determine the wavelength are possible. For example, the wavelength may be measured using a cross-sectional view of the wave structure. Another option would be to measure it in an optical setup, using the waves as a grating. The resulting spectrum of a light shining through the film may be used to determine the wavelength.

The amplitude of a wave structure (i.e. the distance from valley to peak of a wave) can be assessed on a film using a z-direction information sensitive microscope. For example, the microscope may be a laser scanning microscope or an atomic force microscope. The resolution in the z-direction should be at least as small as the tens of nanometers range.

In some embodiments of the film, the amplitude can be determined on a cut cross-section (i.e. microtome cut, embedded in epoxy and polished, or other routes) in a microscope with appropriate resolution and contrast. As the shrink in a laminate containing many layers is generally less than shrink in a film containing only a polymeric substrate layer, a polymeric buffer layer and an inorganic coating layer, the amplitude may be lower.

As used herein, the “average amplitude” is determined by measurement of the amplitude of at least five individual waves using one or more positions across the film sample in undistorted areas (i.e. wave domains) and calculating the average of these five measurements.

As used herein, “barrier” or “barrier film” or “barrier layer” or “barrier material” refers to providing for reduced transmission to gases such as oxygen (i.e. containing an oxygen barrier material). The barrier material may provide reduced transmission to moisture (i.e. containing a moisture barrier material). The barrier characteristic may be provided by one or more, or a blend, of multiple barrier materials. The barrier layer may provide the specific barrier required to preserve the product within a package throughout an extended shelf-life which may be several months or even more than one year.

The barrier may reduce the influx of oxygen through the durable barrier film during the shelf-life of a packaged product (i.e. while the package is hermetically sealed). The oxygen transmission rate (OTR) of the durable barrier film is an indication of the barrier provided and can be measured according to ASTM F1927 using conditions of 1 atmosphere, 23° C. and 50% RH.

As used herein, a “durable barrier film” or “hermetically sealed package” or “retort stable package” is a film, or package made from the film, that maintains a high barrier level with little degradation after exposure to at or above the shrink onset temperature. The packages are such that can be filled with product, sealed, and remain hermetically sealed, maintaining excellent barrier properties.

As used herein “Degradation Factor” refers to the increase of a barrier measurement. The barrier measurement may be oxygen transmission rate or moisture transmission rate and the increase of the barrier measurement represents a decrease in actual barrier levels, thus a degradation in barrier. The loss in barrier (i.e. increase in transmission rate), is measured at two points in time, typically before and after a specific event. The event may be an abusive process such as heat treatment or physical extension. The measurements of barrier should be completed using a standard method under identical conditions at the two points in time. The degradation factor is calculated as a ratio of the measurements: later value/former value. For example, if an oxygen transmission rate of a film is measured to be 0.25 before a heat treatment cycle and 0.75 after the heat treatment cycle, the degradation factor is 3 (0.75/0.25).

As used herein, the Young's modulus or elastic modulus is a measure of a materials ability to change dimension when under tensile or compressive force, in units of force per unit area. A material with a higher Young's modulus may be relatively stiff while a material with a lower Young's modulus is relative soft and pliable (i.e. elastic). Young's modulus can be calculated from a force-displacement data set derived from a nanoindentation test procedure.

As used herein, “ASTM E2546-15 Annex X.4” refers to an instrumented indentation test procedure according to the documented standard using apparatus including a silicon tip mounted on a silicon cantilever with a defined tip radius of 30 nm.

The durable barrier films described herein may be useful as retort packaging films. As used herein, a “retort packaging film” or “retort packaging” is a film, or package made from the film, that can be filled with product, sealed, and remain hermetically sealed after being exposed to a typical retort sterilization process. Typical retort sterilization is a batch process that uses temperatures from about 100° C. to about 150° C., over-pressure up to about 70 psi (483 kPa), and may have a duration from a few minutes up to several hours. Common retort processes used for products packaged in flexible films include steam or water immersion. Food or other products packaged in retort packaging film and retort sterilized can be stored at ambient conditions for extended periods of time (i.e. are shelf-stable), retaining sterility. Because the retort process is incredibly abusive, very specialized flexible packaging films have been designed to survive the process.

It was surprisingly found that a film structure could be developed to incorporate the formation of a wave structure in the inorganic coating layer upon heating of the film structure. Upon heating, the film structure maintained the performance properties necessary for these films to be used in packaging applications and other similar uses. For instance, the layers necessary for wave formation were also able to include necessary bonding to adjacent layers, have appropriate flexibility and clarity, and provide durability through other environmental conditions beyond thermal exposure (i.e. flexing, puncture, humidity, etc.).

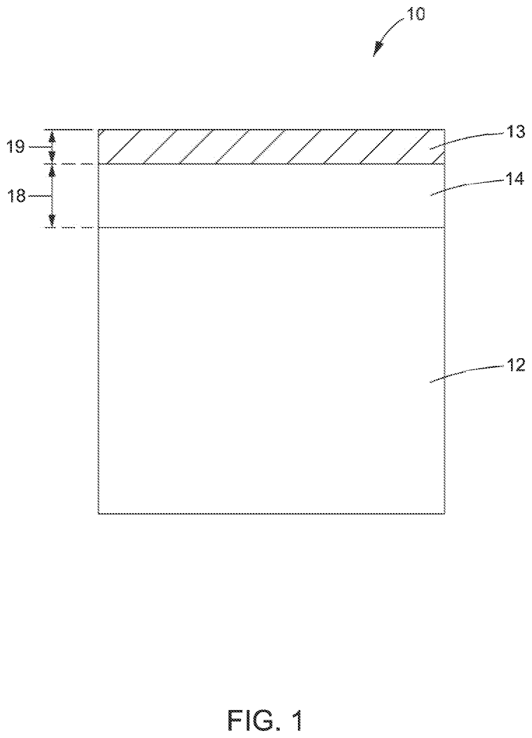

We now turn to the specific details of an embodiment of a structure of a durable barrier film. In FIG. 1, the durable barrier film 10 includes a polymeric substrate layer 12, an inorganic coating layer 13 and a polymeric buffer layer 14 positioned between the polymeric substrate layer 12 and the inorganic coating layer 13. The polymeric buffer layer 14 is in direct contact with the inorganic coating layer 13. The polymeric buffer layer 14 may be in direct contact with the polymeric substrate layer 12, as shown in FIG. 1, or there may be one or more additional layers between them.

The polymeric substrate layer has a free shrink value greater than zero in at least one of the machine direction or the transverse direction at the shrink onset temperature of the durable barrier film in which it is comprised. The free shrink of the polymeric substrate layer experienced at the shrink onset temperature, or another temperature above the shrink onset temperature to which the durable barrier film is exposed, causes a decrease in the surface area of the polymeric substrate layer. Any layer adjacent to or near the shrinking polymeric substrate layer experiences a shrink force in the x-y direction, due to the reduction of surface area.

The free shrink of the polymeric substrate layer at the shrink onset temperature may be between 0.5% and 50%, between 0.5% and 25%, between 1% and 10% or between 1% and 6%. The free shrink of the polymeric substrate layer may be measured on the polymeric substrate layer alone (including any sublayers that may be present). Alternatively, the free shrink of the polymeric substrate layer may be measured on a combination of the polymeric substrate layer and the polymeric buffer layer, plus any intervening layers, together. The free shrink of the polymeric substrate layer may be measured when it is connected to the inorganic coating layer, including the polymeric buffer layer and any other intervening layers.

The polymeric substrate layer comprises any polymer including but not limited to polyester, polyethylene, polypropylene, polyamide, and polylactic acid, or blends of polymers. The polymeric substrate layer may comprise any number of sublayers. The sublayers of the polymeric substrate layer may include polymers within the same polymer class (i.e. all layers are various types of polypropylene polymers) or the sublayers may be of different polymer classes. The polymeric substrate layer may be oriented or non-oriented. The polymeric substrate layer may be relatively clear, translucent, or opaque. The polymeric substrate layer may have printed indicia deposited on either of the major surfaces.

The polymeric substrate layer may be a film and the film may be produced by any known process, for example blown film or cast film. The polymeric substrate layer may be a monoaxially oriented polypropylene film (MDOPP), a biaxially oriented polypropylene film (BOPP), a monoaxially oriented polyethylene film (MDOPE), a biaxially oriented polyethylene film (BOPE), a monoaxially oriented polyester films (MDO PET) or a biaxially oriented polyester film (BOPET). The polymeric substrate layer may be produced using specific polymers and may be oriented using specific conditions which optimize the heat resistance of the film.

The polymeric substrate layer may have a thickness (prior to shrinking) between 6 μm and 100 μm. In some embodiments, the polymeric substrate layer may have a thickness between 10 μm and 50 μm, or between 10 μm and 30 μm.

The inorganic coating layer of the durable barrier film is a metal or inorganic oxide that has been applied by a vacuum deposition process, such as chemical vapor deposition or physical vapor deposition. Alternatively, the inorganic coating layer may be applied using a wet chemistry technique. The inorganic coating layer is deposited on the surface of the polymeric buffer layer. The inorganic coating layer is directly adjacent to and in direct contact with the polymeric buffer layer.

The inorganic coating layer provides a significant contribution to the oxygen barrier (OTR reduction) to the durable barrier film. The inorganic coating layer may be transparent oxide coating such as AlOx (i.e. aluminum oxide) or SiOx (i.e. silicon oxide). The oxide coating may be produced by a vacuum deposition process.

The inorganic coating layer may include a metal layer such as aluminum or a blend of aluminum and another metal. The metal layer may be produced by a vacuum deposition process.

Referring to FIG. 1 again, the inorganic coating layer 13 has a thickness 19 measured in the z-direction. The inorganic coating layer 13 has a thickness 19 between 0.005 μm and 0.1 μm, between 0.005 μm and 0.06 μm, between 0.01 μm and 0.1 μm or between 0.01 μm and 0.06 μm. An inorganic coating layer having thickness greater than these ranges results in a layer that is not able to flex into the wave structure to accommodate the surface area change without cracking or otherwise failing.

The polymeric buffer layer of the durable barrier film is located between the polymeric substrate layer and the inorganic coating layer. The polymeric buffer layer is in direct contact with the inorganic coating layer. The polymeric buffer layer may be in direct contact with the polymeric substrate layer. The polymeric buffer layer may be a layer within a film that also contains the polymeric substrate layer. In some embodiments of the durable barrier film there may be intervening layers between the polymeric buffer layer and the polymeric substrate layer.

Without limiting, embodiments of the polymeric buffer layer may include polymers such as vinyl alcohol copolymer, polyurethane-based polymer, polypropylene-based polymer, polylactic acid-based polymer, blends of these polymers or blends of these materials with other materials. Again, without limiting, the polymeric buffer layer may be produced by coating, extrusion, coextrusion or lamination. The buffer layer may have an intrinsic barrier property (oxygen or moisture barrier), that may contribute to the overall barrier property of the durable barrier film.

Referring to FIG. 1 again, the polymeric buffer layer 14 has a thickness 18 measured in the z-direction. The polymeric buffer layer 14 has a thickness 18 between 0.5 μm and 12 μm, between 1 μm and 5 μm, or between 1 μm and 2.5 μm.

The ratio of the thickness of the polymeric buffer layer of the durable barrier film to the thickness of the inorganic coating layer of the durable barrier film is between 20 and 500, or between 30 and 120. A ratio of thicknesses within this range is one of the combination of factors that allow for formation of a wave structure in the inorganic coating layer upon shrinking of the polymeric substrate layer.

The polymeric buffer layer has a Young's modulus of between 0.1 MPa and 100 MPa at an elevated temperature, such as the shrink onset temperature of the durable barrier film. This property of the polymeric buffer layer, in conjunction with the location and thickness of the polymeric buffer layer among other details of the film structure, advantageously allows for the formation of the wave structure in the inorganic coating layer as the polymeric substrate layer shrinks, preventing cracking and loss of barrier properties.

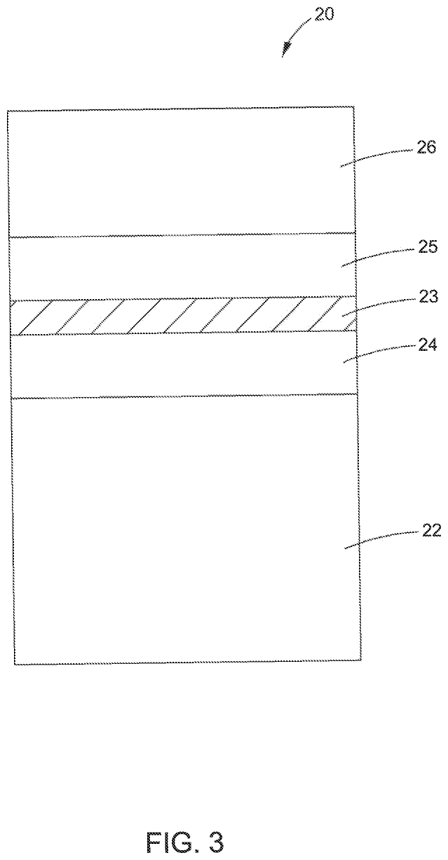

The durable barrier film may also include additional layers. The durable barrier film 20 shown in FIG. 3 is a non-limiting example including additional layers. In FIG. 3, the durable barrier film 20 includes a polymeric substrate layer 22, an inorganic coating layer 23 and a polymeric buffer layer 24 positioned between the polymeric substrate layer 22 and the inorganic coating layer 23. The polymeric buffer layer 24 is in direct contact with the inorganic coating layer 23. The polymeric buffer layer 24 may be in direct contact with the polymeric substrate layer 22, as shown in FIG. 3, or there may be one or more additional layers between them. Durable barrier film 20 also includes a second polymeric buffer layer 25, located on the opposite side of the inorganic coating layer 23, and in direct contact with the inorganic coating layer 23. Layer 26 is an additional layer which may be a heat-sealing layer or some other functional layer.

The durable barrier film may include an exterior located layer for heat sealing. This allows for the formation of a package by heat sealing to itself or another component. The heat seal layer may comprise polymeric materials. The sealing layer may comprise a formula of polymers designed to reduce the heat seal initiation temperature to compliment the heat resistance of the opposite exterior surface. Even though the sealing layer may have a rather low temperature softening point, the sealing layer may have enough integrity to survive the high temperatures of the retort sterilization process along with other abuses a package may endure during distribution and use.

As shown in FIGS. 1 through 4, the polymeric substrate layer may be located on the exterior of the durable barrier film structure. However, as described in several of the Examples herein, there may be additional layers added to the structure such that the polymeric substrate layer is an interior layer of the structure.

The durable barrier film may have an overall thickness from about 63.5 μm to about 254 μm, or from about 76.2 μm to about 152.4 μm.

The durable barrier films described herein may contain at least 80% or at least 90% polyolefin-based polymers by weight, promoting recyclability of the film and or package in which it is used. Materials that are not polyolefin-based polymers are minimized. For example, the barrier layer of the durable barrier film is a material that is not a polyolefin-based material and thus is provided in as thin of a layer as possible to function properly as a barrier. The film may also have other non-polyolefin materials such as adhesives and inks.

Using the combination of film structure design elements as described herein, a durable barrier film can be achieved. The films may be suitable to be recycled in a polyolefin-based recycling process because of the high polyolefin content. The films may have low levels of, or may be essentially free from, materials such as polyester, polyamide, chlorine containing polymers and aluminum foil. The films may contain non-polyolefin-based polymers such as those used in adhesive layers or ink layers, but these are minimized and generally less than 10% of the overall composition, by weight. The films may contain non-polymeric materials such as barrier materials, but these are minimized and generally less than 10% of the overall composition, by weight.

As previously described herein, an increase in environmental temperature may cause the polymeric substrate layer to shrink slightly. As the temperature rises, the polymeric material softens, releasing tension that may have been embedded in the layer upon production. The tension release may result in a movement and rearrangement of the polymer chains and an ultimate change (increase or decrease) in the dimensions of the layer. A common result of increasing temperature on a polymeric substrate layer is a slight reduction (i.e. shrink) of the substrate in at least one direction parallel with the x-y plane of the layer.

Upon shrinking of the polymeric substrate layer, a compressive force is applied to the other layers within the durable barrier film with the largest force being applied to the adjacent layers. The other layers may also have a shrinking tendency at the elevated temperature, and it is likely that the free shrink of each layer is slightly different. The greatest difference in free shrink is likely found when comparing a layer to the inorganic coating layer of the durable barrier film. Most inorganic coatings experience no shrink at the temperatures at which the polymeric substrate layer will shrink (i.e. the shrink onset temperature, 60° C. or some other temperature). Additionally, inorganic coatings also have very high modulus (high stiffness) at these elevated temperatures.

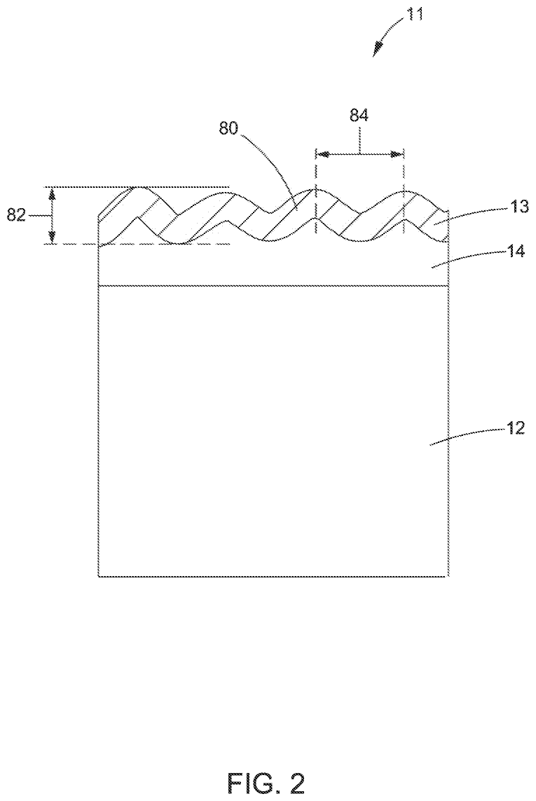

Using the defined structure of the durable barrier film explained herein, upon experiencing an elevated temperature, the polymeric substrate layer, and possibly other layers of the structure, will begin to shrink. The closely located polymeric buffer layer, having a low modulus at the elevated temperature, experiences the x-y direction compressive force and conforms to the stress easily. The surface of the polymeric buffer layer may become slightly more dense or the polymeric buffer layer may become slightly thicker (z-direction) as the surface area (x-y direction) of the polymeric substrate decreases and the material polymeric buffer layer is compressed. The inorganic coating layer, however, is not pliable (i.e. high modulus, high stiffness). As a result of the x-y direction compressive forces from the shrinking polymeric substrate layer, and the low modulus of the underlying (i.e. directly adjacent) polymeric buffer layer, the inorganic coating layer may have a tendency bend into a pattern of waves, the amplitude of the waves forming in the z-direction. The formation of the wave structure preserves the surface area of the inorganic coating layer, preventing the typical cracks that would normally form under the shrink forces. p The view shown in FIG. 2 is the durable barrier film 11 shown in FIG. 1, after exposure to a temperature greater than the shrink on-set temperature of the durable barrier film. FIG. 2 shows the cross-sectional view of an embodiment of a durable barrier film 11 that includes the wave structure 80 in the inorganic coating layer 13. After heat exposure, the polymeric substrate layer 12 has shrunk. At the elevated temperature, the polymeric buffer layer 14 has a modulus low enough that the material can be pliable under the compressive forces, allowing the attached inorganic coating layer 13 to form into a wave structure 80. The wave structure is characterized by a wavelength 84 and amplitude 82.

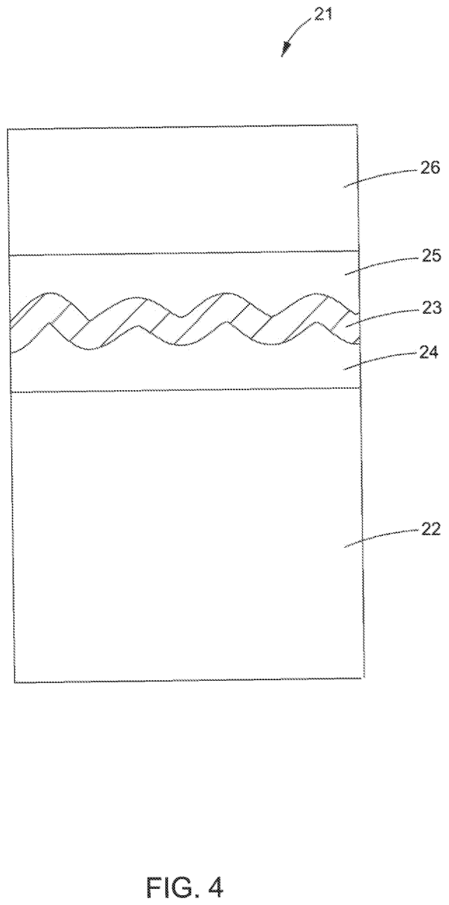

Similarly, FIG. 4 is the durable barrier film 21 shown in FIG. 3, after exposure to a temperature greater than the shrink on-set temperature of the durable barrier film. The inorganic coating layer 23 has taken on a wave structure characterized by a wavelength and amplitude. As shown in FIG. 4, if a second buffer layer 25 is present in the durable barrier film, the second buffer layer also has a low modulus at or above the wave formation temperature, and the second buffer layer is pliable to allow the formation of the wave structure. Alternatively, there may be additional layers (i.e. non-buffer layers) attached to the inorganic coating layer.

In some embodiments of the durable barrier film in which the wave structure has been formed, the average amplitude of the wave structure may be between 0.25 μm and 1.0 μm or between 0.4 μm and 1.0 μm. The wavelength of the wave structure may be between 2 μm and 5 μm. The wave structure may also be characterized by a ratio of the wavelength to the average amplitude of between 2 and 20, or between 4 and 10.

In embodiments of the durable barrier film that include a wave structure formed in the inorganic coating layer, the thickness of the polymeric buffer layer may be between 1.1 and 20 times the average amplitude of the wave structure. In some embodiments the thickness of the polymeric buffer layer may be between 1.5 and 5 times the average amplitude of the wave structure.

In some embodiments, before being exposed to elevated heat conditions, the durable barrier film may have an average oxygen transmission rate (OTR) value that is less than 2 cm³/m²/day, less than 1 cm³/m²/day, less than 0.5 cm³/m²/day, or less than 0.1 cm³/m²/day (measured according to ASTM F1927 using conditions of 1 atmosphere, 23° C. and 50% RH). In some embodiments, after being exposed to a representative retort sterilization process, the durable barrier film has an average OTR value that is less than 2 cm³/m²/day, less than 1 cm³/m²/day, less than 0.5 cm³/m²/day, or less than 0.1 cm³/m²/day. The average OTR value may be near, at or below the minimum detection level of a testing device. The representative retort sterilization process is completed by cutting a DIN A4 sized portion of the retort packaging film and exposing it to a steam sterilization process for 60 minutes at 128° C. and overpressure of 2.5 bar, followed by water shower cooling.

The wave structure may be formed when the durable barrier film is exposed to temperatures above the shrink onset temperature. This may happen in any type of process. For example, during or after the conversion of the durable barrier film, the film may be heated by a roller or an oven. The roller should be heated to a temperature that is capable of raising the film to a temperature above the shrink onset temperature of the film, causing the wave formation to occur. This film can then be used in a packaging application or for another use. Alternatively, the durable barrier film may be exposed to temperatures above the shrink onset temperature during or after forming the material into a package, filling with product and hermetically sealing it closed. The elevated temperature may be part of a retort process or another type of pasteurization. Again, the elevated temperature should be greater than the shrink onset temperature of the durable barrier film so that wave formation occurs.

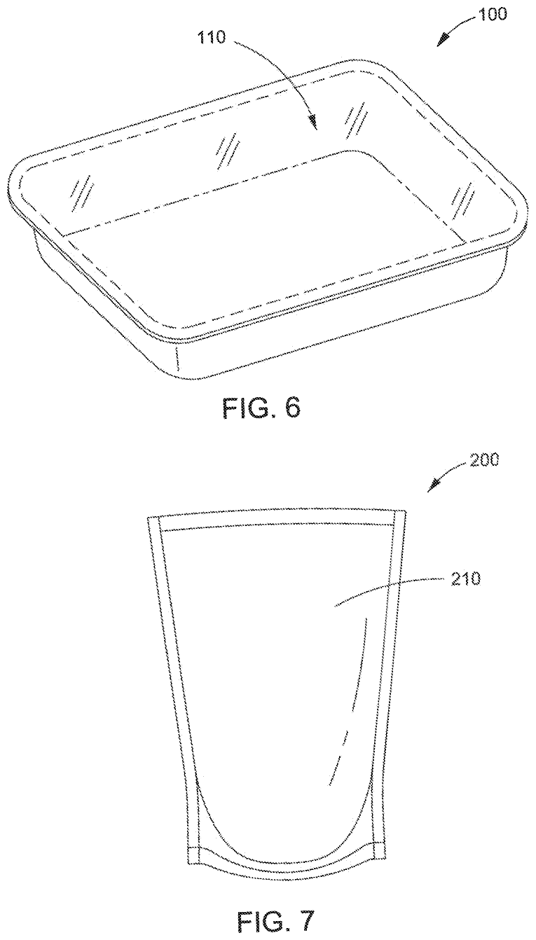

The durable barrier film can be formed into packages, either with or without other packaging components. For example, the durable barrier film 210 can be formed into a flexible stand-up pouch 200 as shown in FIG. 7. In another embodiment of a hermetically sealed package 100, the durable barrier film 110 may be a lid material sealed to a thermoformed tray or cup, as shown in FIG. 6.

The durable barrier film maintains excellent barrier properties and visual appearance, even after the film has been formed into a package, filled, hermetically sealed and undergone the retort sterilization process.

### EXAMPLES & DATA

Several film structures were produced as summarized in Table 1 below.

TABLE 1
Example and Comparative Example Film Structures

| Identification | Structure |
|---|---|
| Example 1a | 18 μm BOPP/1.7 μm PU/0.04 μm SiOx |
| Example 1b | 18 μm BOPP/1.7 μm PU/0.04 μm SiOx/0.7 μm PU |
| Example 2 | 18 μm BOPP/1.7 μm PU/0.03 μm aluminum |
| Comparative | 17.4 μm BOPP/0.6 μm EVOH/0.05 μm SiOx |
| Example 3 | |
| Comparative | 18 μm BOPP/0.04 μm SiOx |
| Example 4 | |
| Comparative | 18 μm BOPP/1.7 μm PU/0.05 μm SiOx |
| Example 5 | |
| Comparative | 18 μm BOPP/0.05 μm SiOx/1.7 μm PU |
| Example 6 | |

The durable barrier films of Example 1a, Example 1b and Example 2 were prepared by applying a water-based polyurethane (PU) dispersion to the surface of an 18 μm biaxially oriented polypropylene film to achieve a 1.7 μm coating after drying the dispersion. A silicon oxide coating or an aluminum layer, respectively, were applied by vapor deposition, to the surface of the PU coating. The sample of Example 1b had an additional layer of the water-based PU dispersion added to the surface of the silicon oxide coating.

Comparative Example 3 was prepared by co-extrusion of a polypropylene layer with an EVOH outer layer, with subsequent bi-axial orientation. To this EVOH layer (i.e. buffer layer), a silicon oxide coating was applied by vapor deposition. Comparative Example 4 was prepared by vacuum deposition of a silicon oxide coating onto the surface of an 18 μm biaxially oriented polypropylene film. There was no intervening material in this structure (i.e. no polymeric buffer layer). Comparative Example 5 was prepared using the same method as Example 1, but a different water-based polyurethane dispersion, Dispurez® 101 available from Incorez Ltd. Comparative Example 6 was prepared using the same method as Example 1a but switching the sequencing of vapor deposition of silicon oxide and application of the polyurethane dispersion. Because of the location of the polyurethane dispersion, Comparative Example 6 does not have a buffer layer as defined herein.

Similarly, several more complex film structures were produced as summarized in Table 2 below.

TABLE 2
Example and Comparative Example Film Structures

| Identification | Structure |
|---|---|
| Example 7 | 60 μm PP/3.5 μm adh/[Example 1a]/3.5 μm |
| | adh/ink/18 μm BOPP |
| Example 8 | 18 μm BOPP/ink/3.5 μm adh/[Example 1a]/3.5 μm |
| | adh/60 μm PP |
| Example 9 | [Example 1a]/3.5 μm adh/60 μm PP |
| Example 10 | [Example 2]/3.5 μm adh/60 μm PP |
| Example 11 | 25 μm MDOPE/0.3 μm primer/1 μm EVOH/0.04 μm |
| | SiOx |
| Example 12 | 19 μm BOPP with HS/0.008 μm SiOx/3.5 μm |
| | adh/60 μm PP |
| Comparative | 19 μm BOPP with HS/0.05 μm SiOx/3.5 μm |
| Example 13 | adh/60 μm PP |
| Example 14 | [Example 1b]/3.5 μm adh/60 μm PP |

The durable barrier film of Example 7 was prepared from the structure described in Example 1a, by adhesive laminating a printed 18 μm biaxially oriented polypropylene film to the silicon oxide coating layer and adhesive laminating a 60 μm polypropylene sealing layer to the opposite side (BOPP). Example 8 was prepared in a similar fashion, but with the Example 1a sub-structure flipped. The printed 18 μm biaxially oriented polypropylene film was attached to the 18 μm BOPP side of Example 1a.

Examples 9 and 10 were prepared by adhesive laminating a 60 μm polypropylene sealing layer to the inorganic coating layer of Example 1a and Example 2, respectively. Example 14 was prepared by adhesive laminating a 60 μm polypropylene sealing layer to the exposed PU buffer layer of Example 1b.

Example 11 was prepared by applying a water based polyurethane based primer followed by a water based EVOH lacquer to the surface of a 25 μm MDOPE film to achieve a 1 μm thick coating after drying the lacquer. A silicon oxide coating was applied by vapor deposition onto the lacquer surface.

Example 12 and Comparative Example 13 were prepared by first depositing a silicon oxide coating layer onto the heat sealable surface of a 19 μm heat sealable biaxially oriented polypropylene (BOPP with HS). The heat sealable layer of the BOPP film was approximately 0.7 μm thick and is of a material that is appropriate for a buffer layer. Next, a 60 μm polypropylene sealing layer was adhesively laminated to the silicon oxide coating layer.

For each of the Example structures and Comparative Example structures listed in Tables 1 and 2, Table 3 contains the shrink onset temperature of the example film, as measured by a hot oven modification of ASTM D2732. Additionally, Table 3 lists the polymeric substrate layer of the structure (or the equivalent thereof for the comparative examples), and the free shrink of this layer at the shrink onset temperature of the structure. Finally, Table 3 lists the polymeric buffer layer of the structure (or the equivalent thereof for the comparative examples), and the Young's modulus of the buffer layer material at the shrink onset temperature of the structure.

TABLE 3
Shrink Onset Temperature of Structure, Free Shrink of Polymeric Substrate
Layer and Elevated Temperature Young's Modulus of Polymeric Buffer Layer

| | Shrink | | | | |
|---|---|---|---|---|---|
| | Onset | Polymeric | Free | Polymeric | Young's |
| | Temperature | Substrate | Shrink | Buffer | Modulus |
| Identification | (° C.) | Layer | (%) | Layer | (MPa) |
| Example 1a | 80 | 18 μm | 1 | 1.7 μm PU | 28 |
| | | BOPP | | | |
| Example 1b | 80 | 18 μm | 1 | 1.7 μm PU & | 28 |
| | | BOPP | | 0.7 μm PU | |
| Example 2 | 80 | 18 μm | 1 | 1.7 μm PU | 28 |
| | | BOPP | | | |
| Comp. | 75 | 17.4 μm | 1 | 0.6 μm EVOH | 2,500 |
| Example 3 | | BOPP | | | |
| Comp. | 80 | 18 μm | 1 | N/A | N/A |
| Example 4 | | BOPP | | | |
| Comp. | 80 | 18 μm | 1 | 1.7 μm PU | 900 |
| Example 5 | | BOPP | | | |
| Comp. | 80 | 18 μm | 1 | N/A | N/A |
| Example 6 | | BOPP | | | |
| Example 7 | 100 | 18 μm | 3.6 | 1.7 μm PU | 25 |
| | | BOPP | | | |
| Example 8 | 100 | 18 μm | 3.6 | 1.7 μm PU | 25 |
| | | BOPP | | | |
| Example 9 | 90 | 18 μm | 2.6 | 1.7 μm PU | 27 |
| | | BOPP | | | |
| Example 10 | 90 | 18 μm | 2.6 | 1.7 μm PU | 27 |
| | | BOPP | | | |
| Example 11 | 75 | 25 μm | 1 | 1 μm EVOH | 76 |
| | | MDOPE | | | |
| Example 12 | 95 | 19 μm | 1 | 19 μm | 90 |
| | | BOPP | | BOPP | |
| | | with HS | | with HS | |
| Comp. | 95 | 19 μm | 1 | 19 μm | 90 |
| Example 13 | | BOPP | | BOPP | |
| | | with HS | | with HS | |
| Example 14 | 100 | 18 μm | 3.6 | 1.7 μm PU & | 25 |
| | | BOPP | | 0.7 μm PU | |

The Young's modulus data shown in Table 3 was collected using an atomic force microscopy (AFM) technique utilizing the PinPoint™ Mode on a Park Systems NX10 AFM. To determine the mechanical Young's modulus of the polymeric buffer layer, samples of the polymeric substrate layer/polymeric buffer layer were mounted on a heating stage. The stage was heated to the appropriate test temperature. A silicon tip mounted on a silicon cantilever with a defined tip radius of 30 nm (SD-R30-FM, available from NanoAndMore GmbH) was used for force spectroscopy. Young's modulus was calculated from the resulting force-displacement curve.

For each of the Example structures and Comparative Example structures listed in Tables 1 and 2, Table 4 contains the layer thickness ratio for the polymeric buffer layer and the inorganic coating layer.

TABLE 4
Ratio of Polymeric Buffer Layer Thickness
to Inorganic Coating Layer Thickness

| | Polymeric Buffer | Inorganic Coating | |
|---|---|---|---|
| | Layer Thickness | Layer Thickness | |
| Identification | (μm) | (μm) | Ratio |
| Example 1a | 1.7 | 0.04 | 42.5 |
| Example 1b | 1.7 | 0.04 | 42.5 |
| Example 2 | 1.7 | 0.03 | 56.7 |
| Comp. | 0.6 | 0.05 | 12.0 |
| Example 3 | | | |
| Comp. | 1.7 | 0.05 | 34.0 |
| Example 5 | | | |
| Example 7 | 1.7 | 0.04 | 42.5 |
| Example 8 | 1.7 | 0.04 | 42.5 |
| Example 9 | 1.7 | 0.04 | 42.5 |
| Example 10 | 1.7 | 0.03 | 56.7 |
| Example 11 | 1 | 0.038 | 26.3 |
| Example 12 | 0.7 | 0.008 | 87.5 |
| Comp. | 0.7 | 0.05 | 14 |
| Example 13 | | | |
| Example 14 | 1.7 | 0.04 | 42.5 |

Table 5 contains a summary of wave formation for the Example and Comparative Example structures. The structures were heated to a temperature above the shrink onset temperature of the structure and subsequently inspected for waves.

The durable barrier film of Example 7 was formed into a stand-up pouch package configuration (see FIG. 7), filled with product and hermetically sealed. The package then was subjected to a retort sterilization process using conditions of 127° C. and 50 minutes. During the retort processing, the silicon oxide coating layer underwent wave formation, resulting in a film that has very low crack formation in the inorganic oxide layer and a package that has superior oxygen barrier properties.

Flat films and laminates were used to test wave formation under heating conditions and the resulting wave characteristics are reported in Table 5. Barrier data is reported in Tables 6a and 6b. Samples were retorted in a laboratory vertical autoclave system (FVA/A1, Fedegari Autoclavi S.p.A, Italy) for the given time and temperature at overpressure. Alternately, some samples were exposed to dry heat in a laboratory oven for given times and temperatures, making sure, temperatures are equilibrated during the heating process.

TABLE 5
Wave Formation in Examples and Comparative Examples

| | | | | | Ratio: | |
|---|---|---|---|---|---|---|
| | | | | | Buffer Layer | Ratio: |
| | | | Ave. | | Thickness/ | Wavelength/ |
| | Heating | Waves | Amp. | Wavelength | Ave. | Ave. |
| Identification | conditions | Present? | (nm) | (μm) | Amplitude | Amplitude |
| Comp. | Retort, | No | N/A | N/A | N/A | N/A |
| Example 3 | 127° C., 50 | | | | | |
| | minutes | | | | | |
| Comp. | Retort, | No | N/A | N/A | N/A | N/A |
| Example 4 | 127° C., 50 | | | | | |
| | minutes | | | | | |
| Comp. | Oven, | No | N/A | N/A | N/A | N/A |
| Example 5 | 130° C., 5 | | | | | |
| | minutes | | | | | |
| Comp. | Retort, | No | N/A | N/A | N/A | N/A |
| Example 6 | 127° C., 50 | | | | | |
| | minutes | | | | | |
| Example 7 | Retort, | Yes | 650 | 3.5 | 1.7/0.65 = | 3.5/0.65 = |
| | 127° C., 50 | | | | 2.6 | 5.4 |
| | minutes | | | | | |
| Example 8 | Retort, | Yes | 780 | 3.5 | 1.7/0.78 = | 3.5/0.78 = |
| | 127° C., 50 | | | | 2.18 | 4.5 |
| | minutes | | | | | |
| Example 9 | Retort, | Yes | 720 | 4.5 | 1.7/0.72 = | 4.5/0.72 = |
| | 127° C., 50 | | | | 2.36 | 6.25 |
| | minutes | | | | | |
| Example 10 | Exposure to | Yes | N/A | N/A | N/A | N/A |
| | 130° C., 15 | | | | | |
| | minutes | | | | | |
| Example 11 | Exposure to | Yes | 230 | 2.1 | 1/0.23 = | 2.1/0.23 = |
| | 95° C., 5 | | | | 4.34 | 9.1 |
| | minutes | | | | | |
| Example 12 | Retort, | Yes | N/A | 0.8 | N/A | N/A |
| | 127° C., 50 | | | | | |
| | minutes | | | | | |
| Comp. | Retort, | Yes | 550 | 4 | 0.7/0.55 = | 4/0.55 = |
| Example 13 | 127° C., 50 | | | | 1.27 | 7.3 |
| | minutes | | | | | |

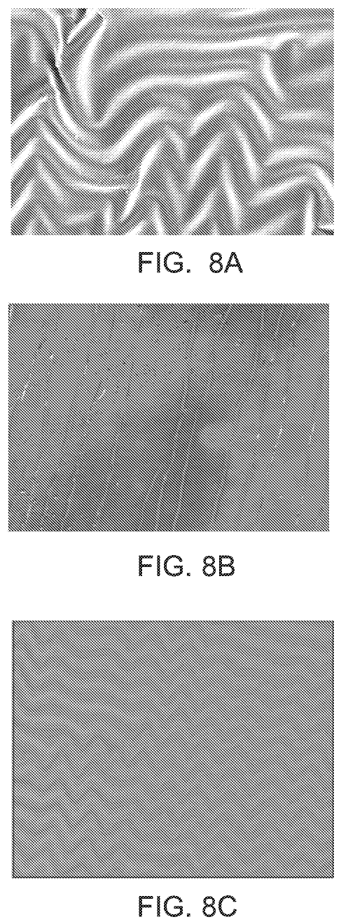

Top view micrographic photos of Example 1, Comparative Example 5 and Example 7 are shown in FIGS. 8A, 8B, and 8C, respectively. Note that these three photos are not at the same magnification and do not show relative wave characteristics. Rather, they show clear wave formation of various patterns (FIGS. 8A and 8C) and an example of no wave formation, including clear cracks in the inorganic coating layer (FIG. 8B).

TABLE 6a
Average Oxygen Transmission Data for Example
and Comparative Example Structures

| | OTR* - before | OTR* - after | Ratio: after/ |
|---|---|---|---|
| Identification | heating | heating | before |
| Comp. | 5 | 39 | 7.8 |
| Example 5 | | | |
| Comp. | 0.1 | 14 | 140 |
| Example 6 | | | |
| Example 7 | 0.1 | 0.5 | 5 |
| Example 8 | 0.1 | 0.5 | 5 |
| Example 9 | 0.1 | 0.5 | 5 |
| Example 10 | 0.1 | 0.18 | 1.8 |
| Example 11 | 0.01 | 0.04 | 4 |
| Example 12 | 33.7 | 63.7 | 1.9 |
| Comp. | 3.54 | 149.3 | 42 |
| Example 13 | | | |
| Example 14 | 0.07 | 0.16 | 2.3 |

*OTR units are cm³/(m² 24 h bar) measured by ASTM 3985-2005, using 23° C. and 50% rh.

TABLE 6b
Moisture Transmission Data for Example
and Comparative Example Structures

| | MVTR** - | MVTR** - | Ratio: after/ |
|---|---|---|---|
| Identification | before heating | after heating | before |
| Comp. | 1.4 | 2.8 | 2.0 |
| Example 5 | | | |
| Comp. | 1.4 | 3.8 | 2.7 |
| Example 6 | | | |
| Example 7 | 0.5 | 1.4 | 2.8 |
| Example 9 | 0.5 | 1.4 | 2.8 |
| Example 10 | 0.9 | 2 | 2.2 |
| Example 11 | 0.3 | 1.4 | 4.6 |
| Example 12 | 3.2 | 3.1 | 1 |
| Comp. | 0.71 | 2.5 | 3.5 |
| Example 13 | | | |
| Example 14 | 0.73 | 0.93 | 1.3 |

**WVTR units are g/(m² 24 h bar) measured by ASTM F 1249-90 Using 38° C. and 90% rh.

The result of the wave formation on the barrier performance of the film structures is evident from the data of Tables 6a and 6b. The films that are designed to allow for wave formation upon heating and shrinking of the film have significantly less oxygen barrier loss (less OTR increase).

1.-13. (canceled)

14. A durable barrier film comprising:
a polymeric substrate layer,
an inorganic coating layer, and
a polymeric buffer layer positioned between the polymeric substrate layer and the inorganic coating layer, the polymeric buffer layer in direct contact with the inorganic coating layer,
wherein
the polymeric substrate layer comprises a thickness between 10 μm and 100 μm,
the inorganic coating layer comprises a wave structure characterized by an average amplitude comprised between 0.25 μm and 1.0 μm and a wavelength comprised between 2 μm and 5 μm, and
the polymeric buffer layer comprises a thickness between 1.1 and 20 times the average amplitude of said wave structure.

15. The durable barrier film according to claim 14 wherein the wave structure of the inorganic layer is characterized by ratio of the wavelength to the average amplitude comprised between 2 and 20.

16. The durable barrier film according to claim 14 wherein the inorganic layer comprises a metal layer or oxide coating and the thickness of the inorganic coating layer is comprised between 0.005 μm and 0.1 μm.

17. The durable barrier film according to claim 14 wherein the polymeric substrate layer comprises a monoaxially oriented polypropylene film, a biaxially oriented polypropylene film, a monoaxially oriented polyethylene film, a biaxially oriented polyethylene film, a monoaxially oriented polyester films or a biaxially oriented polyester film.

18. The durable barrier film according to claim 14 wherein the polymeric substrate layer comprises an oriented polyolefin film.

19. The durable barrier film according to claim 14 wherein the polymeric buffer layer comprises polypropylene, polyurethane or polylactic acid.

20. The durable barrier film according to claim 14 further comprising a second polymeric buffer layer in direct contact with the inorganic coating layer.

21. The durable barrier film according to claim 14 further comprising one or more additional polyolefin layers.

22. The durable barrier film according to claim 14 wherein:
the polymeric substrate layer comprises a biaxially oriented polypropylene film with a thickness between 10 and 50 μm,
the inorganic coating layer comprises vacuum deposited aluminium, AlOx or SiOx and the thickness of the inorganic coating layer is comprised between 0.01 and 0.1 μm, and the average amplitude of the wave structure is comprised between 0.4 μm and 1.0 μm.

23. The durable barrier film according to claim 14 wherein:
the polymeric substrate layer comprises a monoaxially oriented polyethylene film, the polymeric buffer layer comprises vinyl alcohol copolymer, the inorganic coating layer comprises vacuum deposited aluminium, AlOx or SiOx, the average amplitude of the wave structure is comprised between 0.15 μm and 1.0 μm, and the wavelength of the wave structure is comprised between 1 μm and 4 μm.

24. The durable barrier film according to claim 22 wherein the polymeric buffer layer comprises polyurethane.

25. A method for the production of the durable barrier film according to claim 14 comprising the steps of:
providing the polymeric substrate layer,
applying the polymeric buffer layer to a surface of the polymeric substrate layer by techniques comprising extrusion, lacquering, spray coating, or solvent evaporation, and
applying the inorganic coating layer to a surface of the polymeric buffer layer by vacuum deposition.

26. The method according to claim 25 further comprising the step of:
applying the second polymeric buffer layer to a surface of the polymeric substrate layer by techniques comprising extrusion, lacquering, spray coating, or solvent evaporation.

27. The method according to claim 25 further comprising the step of:
adhering the one or more additional polyolefin layer to a surface of one or more of the polymeric substrate layer, the inorganic coating layer, the second polymeric buffer layer or another additional polyolefin layer.

28. A hermetically sealed package comprising a durable barrier film according to claim 14.

29. A retort stable package comprising a durable barrier film according to claim 14 wherein:
the ratio of the oxygen transmission rate, according to ASTM 3985-2005, at 25° C. and 50% relative humidity, after retort treatment, to the oxygen transmission, rate before retort treatment, of said multilayer barrier film is equal to or less than 5, and
the oxygen transmission rate, according to ASTM 3985-2005, at 25° C. and 50% relative humidity is less than 0.5 cm³/(m² 24 h bar) before retort treatment and is less than 1 cm³/(m² 24 h bar) after retort treatment at 127° C. during 50 minutes.

30.-31. (canceled)
